(19) United States
(12) Patent Application Publication
(10) Pub. No.: US 2017/0291340 A1
(43) Pub. Date: Oct. 12, 2017

(54) MODULAR UNIT FOR INJECTION-COMPRESSION MOLDING

(71) Applicant: PLASDAN-AUTOMAÇÃO E SISTEMAS, LDA., Marinha Grande (PT)

(72) Inventor: Paulo Juliano PEREIRA DA SILVA ARAUJO, MARINHA GRANDE (PT)

(21) Appl. No.: 15/507,892

(22) PCT Filed: Aug. 26, 2015
(86) PCT No.: PCT/IB2015/056463

§ 371 Date: Mar. 1, 2017

(30) Foreign Application Priority Data
Sep. 2, 2014 (PT) 107865

(51) Int. Cl. B29C 45/56; B29C 45/82

(52) U.S. Cl. CPC B29C 45/561; B29C 45/82; B29C 2045/5635; B29C 2045/564; B29C 2045/5655; B29C 2945/76498; B29C 2945/76505

(57) ABSTRACT

The present application describes a modular unit for injection-compression molding (1). The modular unit for injection-compression molding (1) is arranged between the movable platen of the injection machine (21) and the stationary platen of the injection machine (22), in particular in the half-mold bearing face resulting from the division thereof by the opening joint. This modular unit for injection-compression molding (1) allows a substantial reduction of energy spent by reduction of inertial masses involved. The present application describes a modular unit for injection-compression molding (1) to be used in the production of pieces by injection being installed on any thermoplastic molding process.

### TECHNICAL FIELD

The present application describes a modular unit for injection-compression molding.

### BACKGROUND

The molding process of pieces by means of polymer injection consists of filling at least one cavity in a mold with an amount of molten polymer under pressure, which after a cooling stage, takes up the shape of the cavity.

The mold consists of at least two parts, separable by adjustable planes which are solidary to the stationary and movable platens of an injection machine whose relative movement undertakes the closing and opening of the mold.

When the different parts of the mold are juxtaposed, thus occurring complete closing of the mold, at least one hollow volume or cavities with corresponding geometry to pieces intended to be produced is created on the inside thereof. In single injection process, the molten polymer is then introduced under pressure so that it occupies the entire hollow volume, followed by subsequent cooling. After such cooling stage, the injection machine opens the mold and the pieces are extracted therefrom.

In the injection-compression process, mold closure prior to injection is initially only partial. This partial closure causes the total hollow volume of the cavities to be higher than the final volume when the mold is completely closed. In this stage, the polymer injection required for the execution of the intended piece is then performed, resulting in the partial filling of the cavity available through conventional injection.

The final geometric shape of the piece shall be achieved by further compression, completely closing the mold, so that the polymer thus compressed adapts completely to the cavity walls which will take up the final volume and shape only when the mold is completely closed. Therefore, the compression is performed by the movement of the movable platen in the molding machine.

During the injection process, there are two basic pressure levels: the primary injection pressure exerted on the material in order to overcome flow pressure loss inside the mold, from the inlet until it is completely filled, so load losses generated in the flow dispensing channels, injection nozzles and the walls of the cavity itself; and the secondary or retention pressure exerted on the mass of material during the cooling solidification stage so as to compensate for contraction without any change on the shape defined by the volume of the cavity.

In an injection-compression process, since the mold is not completely closed, a lower load loss occurs during the introduction of the mass injected into the cavity since load losses in cavity walls are lower due to a larger drainage section.

At the end of supplying the mass into the cavity, total closing pressure of the mold is applied, promoting the complete filling of the cavity and shaping of the mass, but there is now the need to overcome the strength generated only on the walls of the cavity. Thus, the polymer will be subjected to smaller rheological efforts, providing a product with improved characteristics, including strength and optical properties. On the other hand, the power consumed in the injection process is significantly reduced.

In the compression process, partial and full closing stages of the mold are obtained exclusively by controlling the movement of the movable platen in the closing units of the injection machine.

Consequently, this control is especially critical in processes with short production cycles, due to the dynamic conditions arising from mass inertia of the platen and associated pieces, which require very precise positioning with high speeds and accelerations.

Machines prepared for performing compression cycles require their own control programs.

### SUMMARY

The present application discloses a modular unit for injection-compression molding positioned between the movable platen of the injection machine and half-mold bearing surface resulting from the division thereof by opening joint by means of the centering ring of the modular unit and comprising:
kinematic systems consisting of at least one kinematic converter and at least one sliding wedge;
ball screw assembly;
ball nut;
a servomotor;
at least one movable base platen;
an hydraulic cylinder consisting of a central hydraulic block and hydraulic cylinder rod;
a pilot suction valve;
compression springs for cavity sealing rim;
cavity sealing rim.

In one embodiment, the modular unit for injection-compression molding comprises a connection for pressure oil supply from the pressure line, provided by the injection machine or, should so not be possible, by any other alternative oil dynamic energy supply.

In another embodiment, the modular unit for injection-compression molding comprises hydraulic connections for pressure oil supply to the control oil dynamic assembly.

In yet another embodiment, the modular unit for injection-compression molding comprises the connection between the hydraulic control circuit connecting hoses to at least one hydraulic connection and also to control and command electric signal connections carried out by interface chips between the modular unit assembly, oil dynamic energy assembly, electric control and base machine electric commands and systems.

In one embodiment, the movable base platen of the modular unit for injection-compression molding is connected to the mold movable structure supporting the mold core and the hydraulic cylinder rod.

In another embodiment, the modular unit for injection-compression molding comprises a small hydraulic unit consisting of a central hydraulic block with hydraulic accumulator and control valves for controlling the hydraulic cylinder incorporated within said unit.

In yet another embodiment, the modular unit for injection-compression molding comprises an electric control system.

The present application further discloses the use of the modular unit for injection-compression molding in the production of pieces by injection molding, it being applied to any thermoplastic molding process.

The present application discloses an operating method of the modular unit for injection-compression molding comprising the following steps:
said modular unit for injection-compression molding is fastened to the movable platen of the injection machine being guided by the centering ring of the modular unit;
the mold is mounted between the movable base platen of the modular unit and the stationary platen of the injection machine;
an hydraulic connection to a mold service outlet of the injection machine is performed;
the closure unit sets a sufficient opening so as to create the space between the mold component structures connected to the movable platen of the injection machine and to the stationary platen of the injection machine, respectively mold structure block A and mold structure block B, and between the mold core and the piece of the cavity required to the complete extraction of the molded piece;
subsequently to maximum expansion of the compression springs of the cavity sealing rim, the closing stage of the mold begins;
subsequently to the mold being closed, the filling stage of the mold begins;
once the injection of molten material is complete the primary compression stage begins;
the servomotor is set in motion triggering the kinematic system;
once the movement of the movable base platen has stopped, the final compression stage begins;
once the final piece cooling time has elapsed, the extraction stage of the final piece begins;
upon ceasing of the movement of the movable base platen into its initial position, the mold is opened allowing the withdrawal of the final piece;
subsequently to the removal of the final piece, the initial conditions of the first step of this method are restored.

In one embodiment, primary compression stage of the method comprises charging oil into the hydraulic cylinder by suction through the pilot suction valve.

In another embodiment, the mold closing stage of the method comprises approaching the movable platen of the injection machine to the stationary platen of the injection machine.

In yet another embodiment, the final compression stage of the method comprises energizing the directional control valve causing piloting of the pilot check valve which opens in order to allow sending high pressure oil contained within the hydraulic accumulator into the chamber of the hydraulic central block.

In one embodiment, the extraction stage of the final piece of the method comprises de-energizing the directional control valve.

In yet another embodiment, the withdrawal of the final piece is held by mold extraction devices.

### General Description

The present application describes a modular unit for injection-compression molding meant to be applied to any molding process of pieces or products by combined injection-compression of thermoplastic polymers.

The modular unit for injection-compression molding undertakes injection-compression on any standard injection machine, without the need to be prepared thereto. So, the technique can be performed without a mandatory change of the base machine, both in mechanical structure and in hydraulic circuits and control systems thereof. It only takes a by-pass for obtaining pressure oil supply from the pressure line, usually designated service molds, easily accessible proximate to the platens of the machinery closure assembly.

The modular unit is designed to be dimensionally compatible with standard dimensions of platens of injection molding machine closure assemblies according to Euromap and SPI standards.

The modular unit may be installed on the movable platen of the closure assembly as if it were an extension thereof.

In machines with injection-compression capability, both opening and closing the mold and controlling the compression movement are performed by relative movement of the movable platen towards or from the stationary platen of the injection machine. This set of actions requires a very demanding dynamic control of high mass constituted by the movable platen, kinematic assemblies moving it and the mold structure.

The modular unit allows not only the closure assembly of the injection machine platens to be carried out in one step, corresponding to closing of the mold structure, but also the compression step to be carried out by electromechanical and hydraulic mechanisms built into the assembly itself constituting the modular unit. This means that the module operates in the injection-compression process as an extension of the movable platen of the machine itself.

After clamping the module on the movable platen of the closure assembly the mold can be installed whose clamping to the movable platen of the unit is made as if it were the movable platen of the closure assembly. Of course, the other part of the mold shall be clamped to the stationary platen of the closure assembly. This platen is designed with clamping bores according to Euromap and SPI standards.

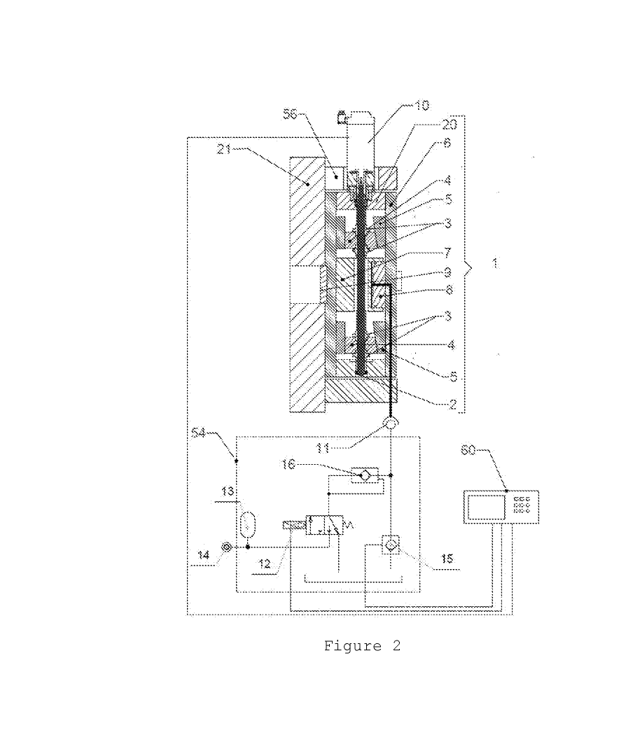

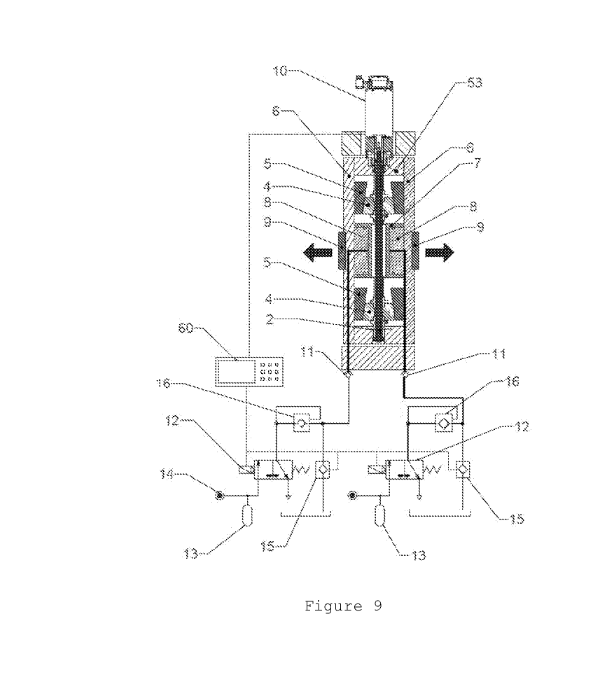

Installation shall be complete upon hydraulic connection of pressure oil supply to control oil dynamic assembly, as shown in FIG. 2 or 9, with hydraulic control circuit connecting hoses connected to at least one hydraulic connection and also to control and command electric signal connections carried out by interface chips between the modular unit assembly, oil dynamic energy assembly, electric control and base machine electric commands and systems. These interconnections include security systems and process signals such as positioning, pressure, temperature or other signals.

The electric control includes means for user-machine communication with possible connection to equivalent systems of the base injection machine.

The modular nature allows the use of the modular unit with an indefinite number of molds dimensionally compatible and which do not require compression power higher to the dynamic system capacities included in the module.

The association of electromechanical servo mechanisms driven by servomotor allows modeling the time and positional profile of the movement of the movable piece of the mold coupled to the platen during primary compression step wherein due to a relatively high gap, strength against molten polymer flow distribution by the molding cavity is reduced. Once primary compression is complete, the hydraulic cylinder consisting of a central hydraulic block and an hydraulic cylinder rod, which was loaded with oil under suction by the pilot suction valve during primary compression step, is connected by joint action of directional control valves and pilot check valves to the high pressure oil accumulator which supplies a small amount of oil at high speed and high pressure, thus creating maximum compressive force made available for final compression stage, which enables total filling of molding cavity for the production of piece or pieces with the desired final shape and size.

### BRIEF DESCRIPTION OF THE FIGURES

For an easier understanding of the technique, drawings are herein attached, which represent preferred embodiments and which, however, are not intended to limit the scope of the present application.

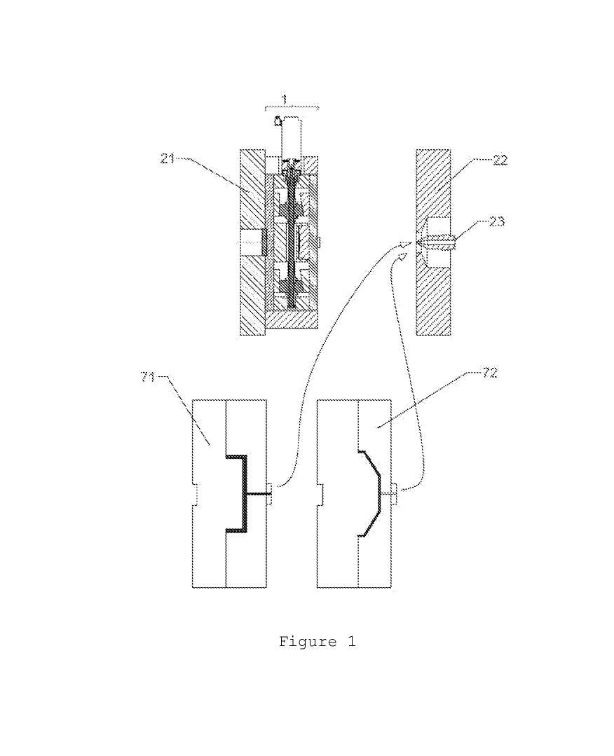

FIG. 1 shows one embodiment of the modular unit installed on the movable platen of an injection machine closure assembly, wherein reference numbers indicate:
1—Modular unit for injection-compression molding;
21—Movable platen of the injection machine;
22—Stationary platen of the injection machine;
23—Injection nozzle I;
71—Mold for product n;
72—Mold for product n+1;

FIG. 2 shows an embodiment of the modular unit for simple injection-compression molding, wherein reference numbers indicate:
1—Modular unit for injection-compression molding;
2—Ball screw;
3—Ball nut;
4—Kinematic converter;
5—Sliding wedge;
6—Movable base platen;
7—Central hydraulic block;
8—Hydraulic cylinder rod;
9—Modular unit centering ring;
10—Spindle actuator;
11—Hydraulic connection;
12—Directional control valve;
13—Hydraulic accumulator;
14—Hydraulic supply point;
15—Pilot suction valve;
16—Pilot check valve;
20—Modular unit structure for simple injection-compression molding;
21—Movable platen of the injection machine;
54—Simple hydraulic assembly;
56—Structure block for mold A;
60—Electric control system.

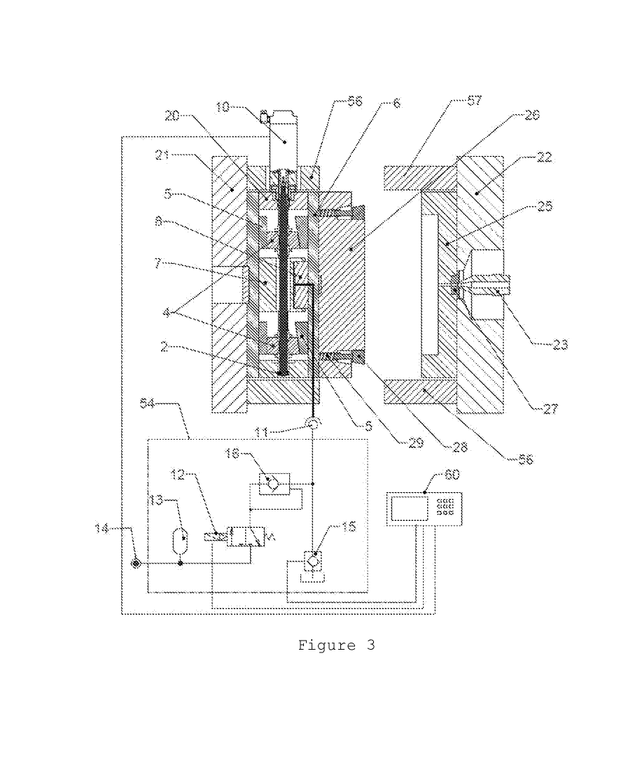

FIG. 3 shows an embodiment of the modular unit for simple injection-compression molding in cycle stage wherein the mold is open, wherein reference numbers indicate:
2—Ball screw;
4—Kinematic converter;
5—Sliding wedge;
6—Movable base platen;
7—Central hydraulic block;
8—Hydraulic cylinder rod;
10—Spindle actuator;
11—Hydraulic connection;
12—Directional control valve;
13—Hydraulic accumulator;
14—Hydraulic supply point;
15—Pilot suction valve;
16—Pilot check valve;
20—Modular unit structure for simple injection-compression molding;
21—Movable platen of the injection machine;
22—Stationary platen of the injection machine;
23—Injection nozzle 1;
25—Mold cavity;
26—Mold core;
27—Mold inlet for injection;
28—Cavity sealing rim;
29—Compression springs for cavity sealing rim;
54—Simple hydraulic assembly;
56—Structure block for mold A;
57—Structure block for mold B;
60—Electric control system.

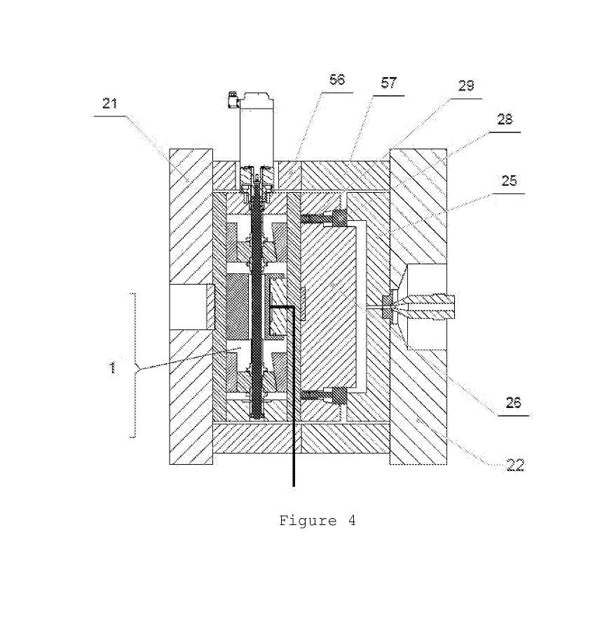

FIG. 4 shows an embodiment of the modular unit for simple injection-compression molding in cycle stage wherein the mold is closed, wherein reference numbers indicate:
1—Modular unit for injection-compression molding;
21—Movable platen of the injection machine;
22—Stationary platen of the injection machine;
25—Mold cavity;
26—Mold core;
28—Cavity sealing rim;
29—Compression springs for cavity sealing rim;
56—Structure block for mold A;
57—Structure block for mold B;

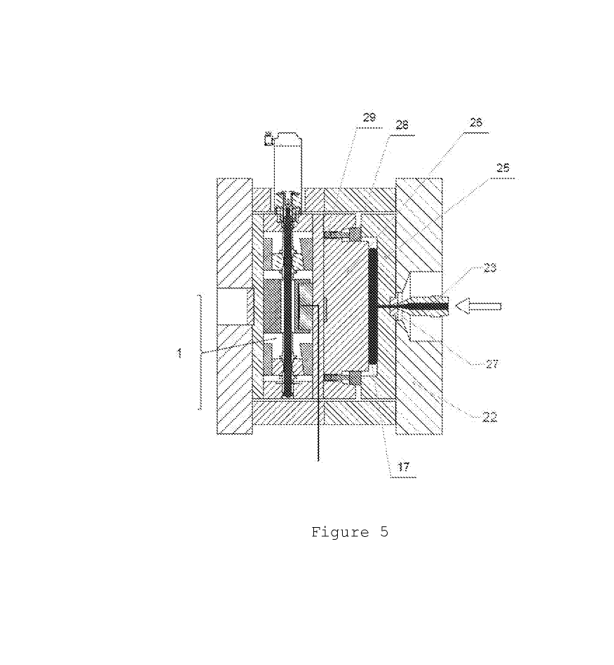

FIG. 5 shows an embodiment of the modular unit for simple injection-compression molding in filling stage of the mold, wherein reference numbers indicate:
1—Modular unit for injection-compression molding;
17—Mold filling stage;
22—Stationary platen of the injection machine;
23—Injection nozzle 1;
25—Mold cavity;
26—Mold core;
27—Mold inlet for injection;
28—Cavity sealing rim;
29—Compression springs for cavity sealing rim.

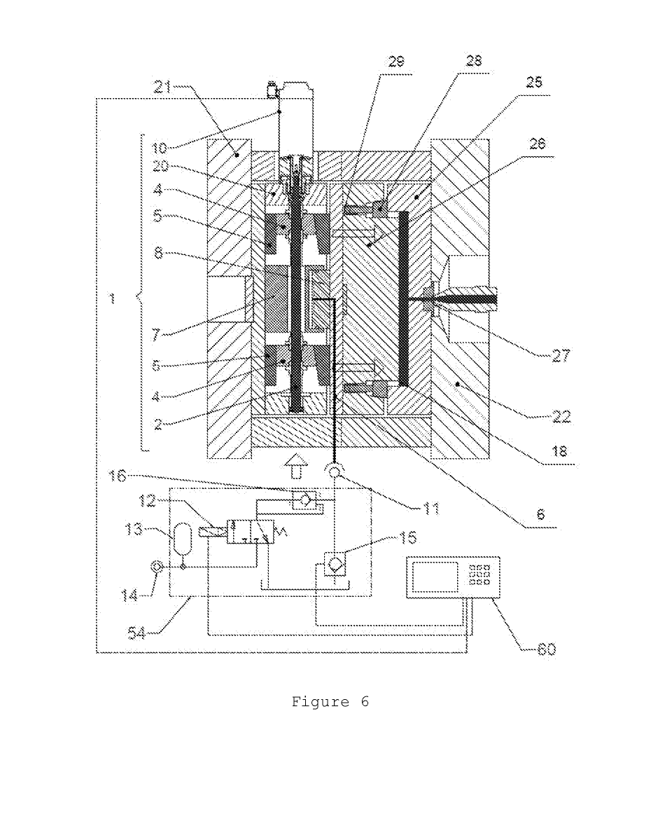

FIG. 6 shows an embodiment of the modular unit for simple injection-compression molding in primary compression stage, wherein reference numbers indicate:
1—Modular unit for injection-compression molding;
2—Ball screw;
4—Kinematic converter;
5—Sliding wedge;
6—Movable base platen;
7—Central hydraulic block;
8—Hydraulic cylinder rod;
10—Spindle actuator;
11—Hydraulic connection;
12—Directional control valve;
13—Hydraulic accumulator;
14—Hydraulic supply point;
15—Pilot suction valve;
16—Pilot check valve;
18—Primary compression stage;
20—Modular unit structure for simple injection-compression molding;
21—Movable platen of the injection machine;
22—Stationary platen of the injection machine;
25—Mold cavity;
26—Mold core;
27—Mold inlet for injection;
28—Cavity sealing rim;
29—Compression springs for cavity sealing rim;
54—Simple hydraulic assembly;
60—Electric control system.

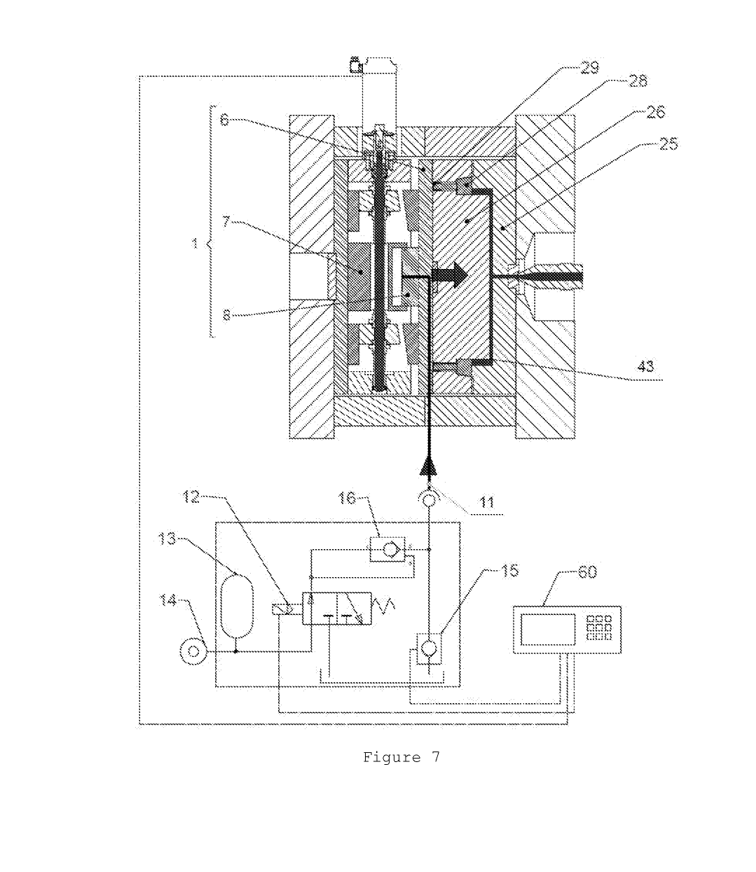

FIG. 7 shows an embodiment of the modular unit for simple injection-compression molding in final compression stage, wherein reference numbers indicate:
1—Modular unit for injection-compression molding;
6—Movable base platen;
7—Central hydraulic block;
8—Hydraulic cylinder rod;
11—Hydraulic connection;
12—Directional control valve;
13—Hydraulic accumulator;
14—Hydraulic supply point;
15—Pilot suction valve;
16—Pilot check valve;
25—Mold cavity;
26—Mold core;
28—Cavity sealing rim;
29—Compression springs for cavity sealing rim;
43—Primary compression;
60—Electric control system.

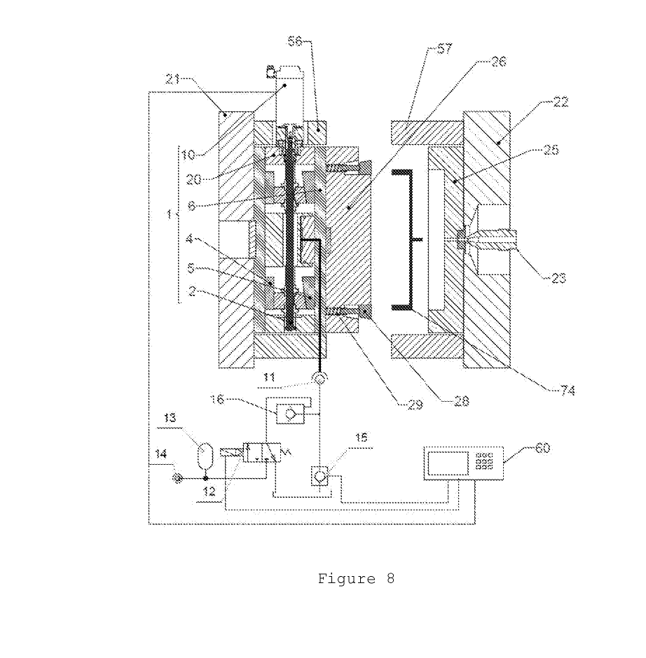

FIG. 8 shows an embodiment of the modular unit for simple injection-compression molding in final piece extraction stage, wherein reference numbers indicate:
1—Modular unit for injection-compression molding;
2—Ball screw;
4—Kinematic converter;
5—Sliding wedge;
6—Movable base platen;
10—Spindle actuator;
11—Hydraulic connection;
12—Directional control valve;
13—Hydraulic accumulator;
14—Hydraulic supply point;
15—Pilot suction valve;
16—Pilot check valve;
20—Modular unit structure for simple injection-compression molding;
21—Movable platen of the injection machine;
22—Stationary platen of the injection machine;
23—Injection nozzle 1;
25—Mold cavity;
26—Mold core;
28—Cavity sealing rim;
29—Compression springs for cavity sealing rim;
56—Structure block for mold A;
57—Structure block for mold B;
60—Electric control system;
74—Final piece.

FIG. 9 shows an embodiment of the modular unit for double injection-compression molding, wherein reference numbers indicate:
2—Ball screw;
4—Kinematic converter;
5—Sliding wedge;
6—Movable base platen;
7—Central hydraulic block;
8—Hydraulic cylinder rod;
9—Modular unit centering ring;
10—Spindle actuator;
11—Hydraulic connection;
12—Directional control valve;
13—Hydraulic accumulator;
14—Hydraulic supply point;
15—Pilot suction valve;
16—Pilot check valve;
53—Modular unit structure for double injection-compression molding;
60—Electric control system.

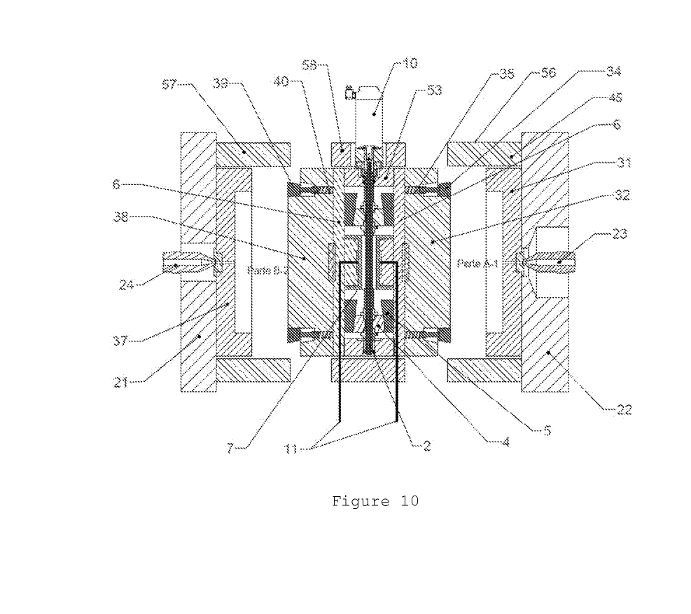

FIG. 10 shows an embodiment of the modular unit for double injection-compression molding in open mold stage, wherein reference numbers indicate:
2—Ball screw;
4—Kinematic converter;
5—Sliding wedge;
6—Movable base platen;
7—Central hydraulic block;
10—Spindle actuator;
11—Hydraulic connection;
21—Movable platen of the injection machine;
22—Stationary platen of the injection machine;
23—Injection nozzle 1;
31—Cavity part in mold 1;
32—Core part in mold 1;
34—Cavity sealing rim 1;
35—Compression springs for cavity sealing rim 1;
37—Cavity part in mold 2;
38—Core part in mold 2;
39—Cavity sealing rim 2;
40—Compression springs for cavity sealing rim 2;
45—Final compression 1;
53—Modular unit structure for double injection-compression molding;
56—Structure block for mold A;
57—Structure block for mold B;
58—Structure block for mold C.

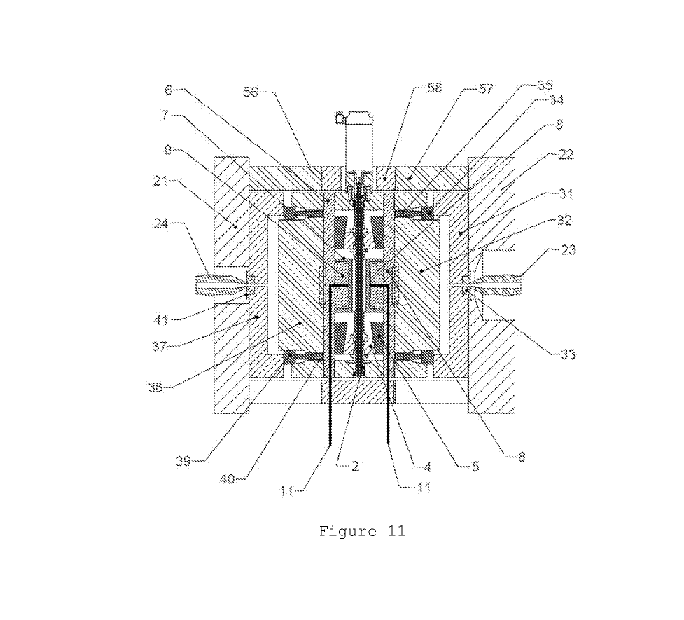

FIG. 11 shows an embodiment of the modular unit for double injection-compression molding in closed mold stage, wherein reference numbers indicate:
2—Ball screw;
4—Kinematic converter;
5—Sliding wedge;
6—Movable base platen;
7—Central hydraulic block;
8—Hydraulic cylinder rod;
11—Hydraulic connection;
21—Movable platen of the injection machine;
22—Stationary platen of the injection machine;
23—Injection nozzle 1;
24—Injection nozzle 2;
31—Cavity part in mold 1;
32—Core part in mold 1;
33—Mold inlet for injection 1;
34—Cavity sealing rim 1;
35—Compression springs for cavity sealing rim 1;
37—Cavity part in mold 2;
38—Core part in mold 2;
39—Cavity sealing rim 2;
40—Compression springs for cavity sealing rim 2;
41—Mold inlet for injection 2;
56—Structure block for mold A;
57—Structure block for mold B;
58—Structure block for mold C.

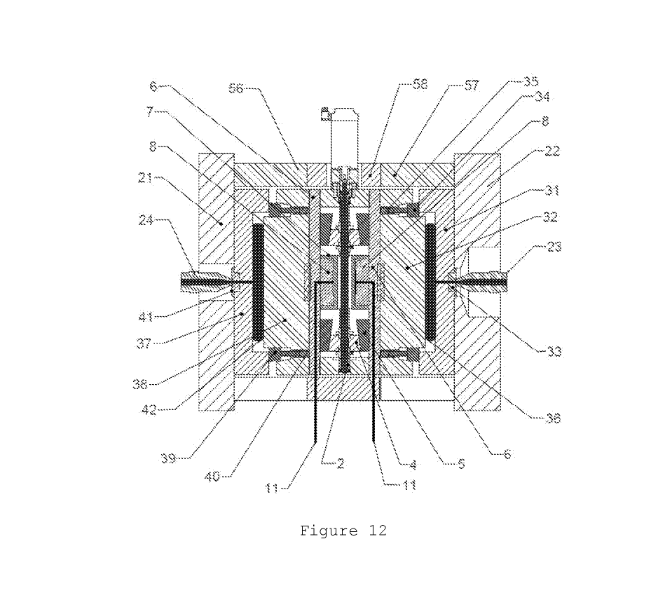

FIG. 12 shows an embodiment of the modular unit for double injection-compression molding in filling stage, wherein reference numbers indicate:
2—Ball screw;
4—Kinematic converter;
5—Sliding wedge;
6—Movable base platen;
7—Central hydraulic block;
8—Hydraulic cylinder rod;
11—Hydraulic connection;
21—Movable platen of the injection machine;
22—Stationary platen of the injection machine;
23—Injection nozzle 1;
24—Injection nozzle 2;
31—Cavity part in mold 1;
32—Core part in mold 1;
33—Mold inlet for injection 1;
34—Cavity sealing rim 1;
35—Compression springs for cavity sealing rim 1;
36—Molding primary filling 1;
37—Cavity part in mold 2;
38—Core part in mold 2;
39—Cavity sealing rim 2;
40—Compression springs for cavity sealing rim 2;
41—Mold inlet for injection 2;
42—Molding primary filling 2;
56—Structure block for mold A;
57—Structure block for mold B;
58—Structure block for mold C.

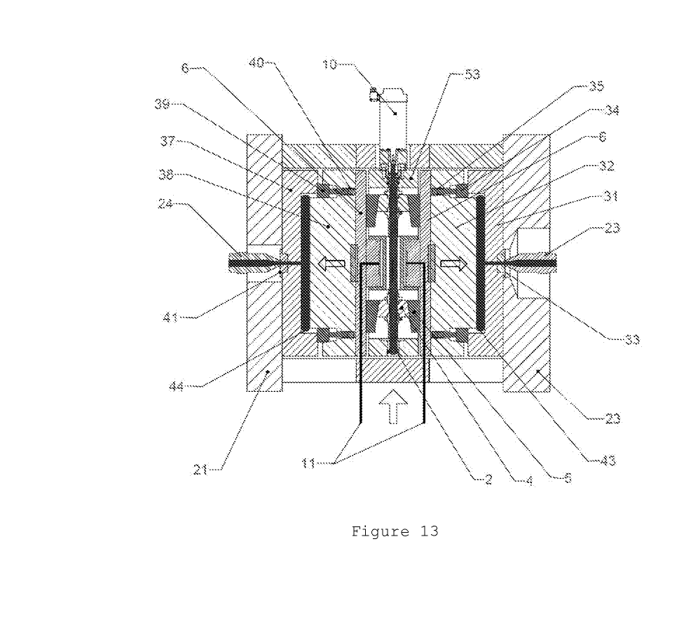

FIG. 13 shows an embodiment of the modular unit for double injection-compression molding in primary compression stage, wherein reference numbers indicate:
2—Ball screw;
4—Kinematic converter;
5—Sliding wedge;
6—Movable base platen;
10—Spindle actuator;
11—Hydraulic connection;
21—Movable platen of the injection machine;
23—Injection nozzle 1;
24—Injection nozzle 2;
31—Cavity part in mold 1;
32—Core part in mold 1;
33—Mold inlet for injection 1;
34—Cavity sealing rim 1;
35—Compression springs for cavity sealing rim 1;
37—Cavity part in mold 2;
38—Core part in mold 2;
39—Cavity sealing rim 2;
40—Compression springs for cavity sealing rim 2;
41—Mold inlet for injection 2;
43—Primary compression;
44—Primary compression 2;
53—Modular unit structure for double injection-compression molding.

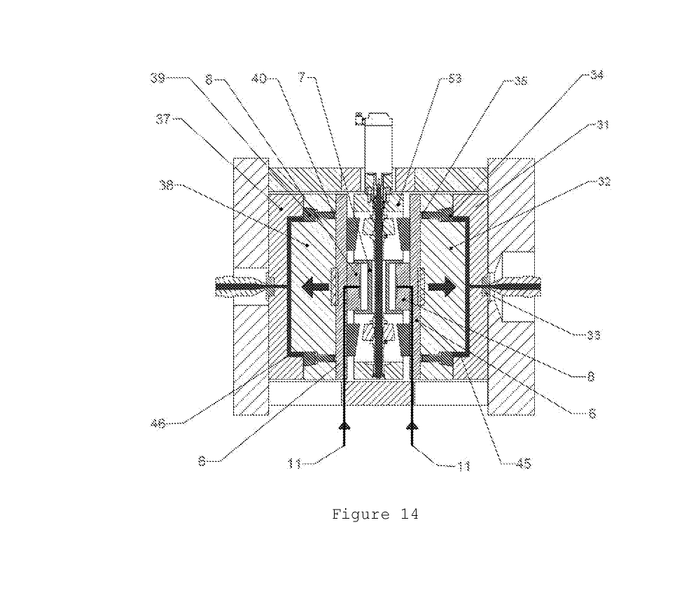

FIG. 14 shows an embodiment of the modular unit for double injection-compression molding in final compression stage, wherein reference numbers indicate:
6—Movable base platen;
7—Central hydraulic block;
8—Hydraulic cylinder rod;
11—Hydraulic connection;
31—Cavity part in mold 1;
32—Core part in mold 1;
33—Mold inlet for injection 1;
34—Cavity sealing rim 1;
36—Molding primary filling 1;
37—Cavity part in mold 2;
38—Core part in mold 2;
39—Cavity sealing rim 2;
40—Compression springs for cavity sealing rim 2;
45—Final compression 1;
46—Final compression 2;
53—Modular unit structure for double injection-compression molding.

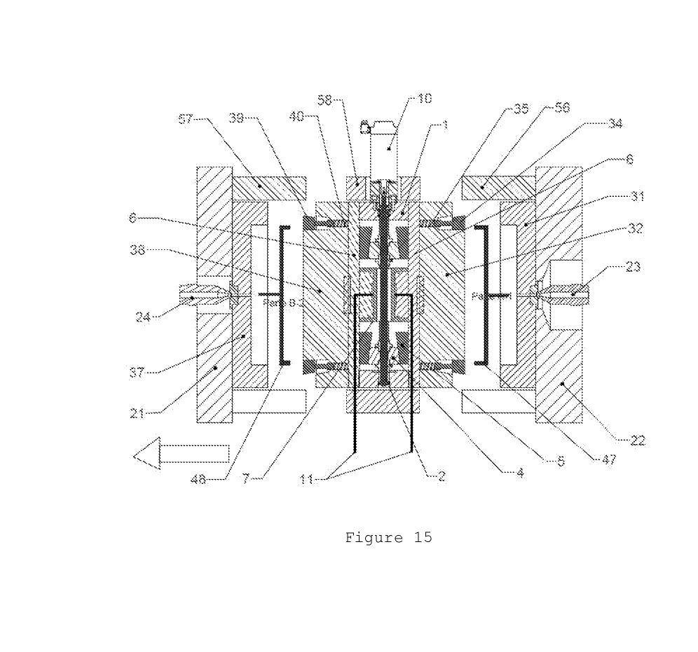

FIG. 15 shows an embodiment of the modular unit for double injection-compression molding in final piece extraction stage, wherein reference numbers indicate:
1—Modular unit for injection-compression molding;
2—Ball screw;
4—Kinematic converter;
5—Sliding wedge;
6—Movable base platen;
7—Central hydraulic block;
10—Spindle actuator;
11—Hydraulic connection;
21—Movable platen of the injection machine;
22—Stationary platen of the injection machine;
23—Injection nozzle 1;
24—Injection nozzle 2;
31—Cavity part in mold 1;
32—Core part in mold 1;
34—Cavity sealing rim 1;
35—Compression springs for cavity sealing rim 1;
37—Cavity part in mold 2;
38—Core part in mold 2;
39—Cavity sealing rim 2;
40—Compression springs for sealing rim 2;
47—Final piece 1;
48—Final piece 2;
56—Structure block for mold A;
57—Structure block for mold B;
58—Structure block for mold C.

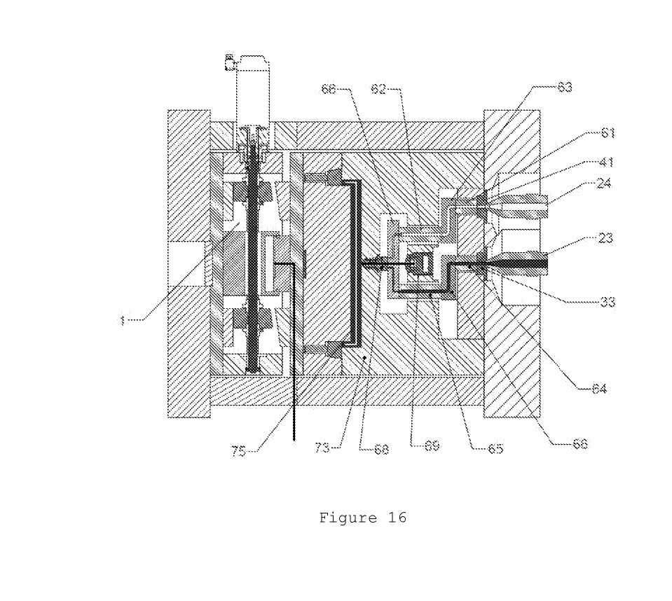

FIG. 16 shows an embodiment of the modular unit for double injection-compression molding for multi-layer products, wherein primary filling of the cavity is carried out by means of co-injection, wherein reference numbers indicate:
1—Modular unit for injection-compression molding;
23—Injection nozzle 1;
24—Injection nozzle 2;
33—Mold inlet for injection 1;
41—Mold inlet for injection 2;
61—Block 1 extension for material A;
62—Block 2 extension for material A;
63—Material A dispenser;
64—Block 1 extension for material B;
65—Block 2 extension for material B;
66—Material B dispenser;
68—Injection/co-injection nozzle;
69—Injection/co-injection nozzle valve actuator;
73—Dispensing and injection system;
75—Co-injection final piece.

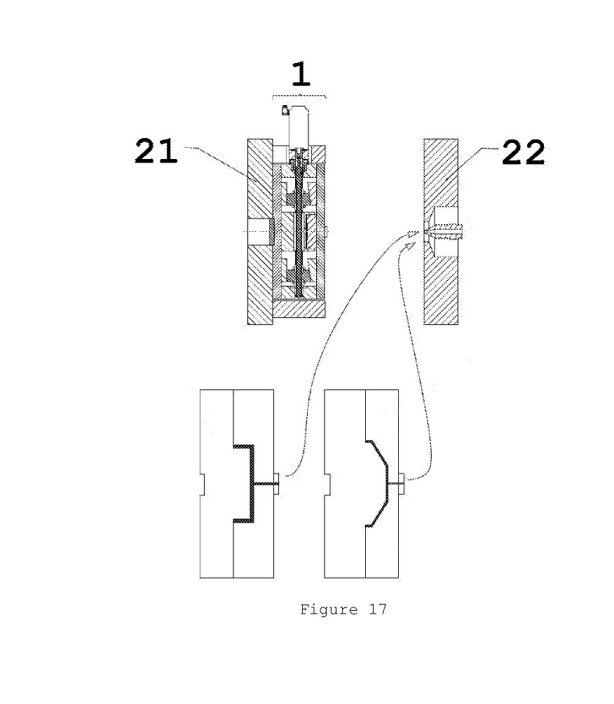

FIG. 17 shows one embodiment of the modular unit installed on the movable platen of an injection machine closure assembly, wherein reference numbers indicate:
1—Modular unit for injection-compression molding;
21—Movable platen of the injection machine;
22—Stationary platen of the injection machine;

### DESCRIPTION OF THE EMBODIMENTS

The present application describes a modular unit for injection-compression molding to enable the use of standard injection molding machines not prepared thereto in an economic way and without significant change to its original composition.

Thus, the original closure assembly of the injection machine shall perform the original mold closing and opening function leaving it up to the modular unit to undertake the intermediate stages in an injection-compression molding cycle. In order to undertake the compression action there is no need to move the high mass of the injection machine closure assembly but rather the movable pieces of the mold itself. Thus, controlling the compression movement shall be more precise and easily moldable and less demanding in terms of power, due to significant reduction of mass inertia involved. In general, only one of the mold parts needs to be moved, the one usually designated as core. This movement, which shall correspond to a progressive reduction in the volume of the molding cavity to obtain the desired compression, shall be performed in a first stage, which shall be designated as primary compression, through the kinematic control provided by a servomotor engine.

Primary compression is carried out until the molding cavity corresponds to a volume proximate to the final volume, i.e. a volume between 102 and 105% of the final volume. The final volume, which shall correspond to the volume of the completely-molded piece, shall be obtained through compression by at least one hydraulic cylinder. This hydraulic force applied during the final molding stage by compression will also allow maintaining the pressure during volume reduction compensation of the molded piece obtained from cooling thereof. The hydraulic pressure and flow rates necessary for hydraulic cylinder operation are obtained from the original machine hydraulic circuit dedicated to the so-called service molds.

The modular unit for injection-compression molding (1) is a tool that can be used for several molds dedicated to injection with compression, such as the mold for product n (71) and the mold product n+1 (72) shown in FIG. 1 which are applied or interleaved between the movable platen of the injection machine (21).

The modular unit for injection-compression molding (1) is designed to be compatible with EUROMAP and SPI dimensions for injection machine closure assemblies, either in dimensional aspects for clamping to the movable platen of the injection machine (21) to the stationary platen of the injection machine (22), or in operating details such as the positioning of the extraction systems.

However, modular units may have another version, designed to be installed in the central body of composite or multi-position molds as shown in FIG. 9 and in any of FIGS. 10 to 15.

FIG. 2 shows an embodiment of the modular unit for simple injection-compression molding (1), mounted on the stationary platen of the injection machine (21).

The modular unit for injection-compression molding (1) comprises a modular unit structure for simple injection-compression molding (20) positioned on the movable platen of the injection machine (21) through the centering ring of the modular unit (9) and secured by suitable fastening accessories.

In the structure of the modular unit for simple injection-compression molding (20) kinematic systems, at least one kinematic converter (4) and at least one sliding wedge (5) may be installed, the kinematic converter being driven by the ball screw (2) and ball nut (3) assembly, which is in turn driven by a servomotor. The kinematic system enables accurate displacement and according to the programmed diagram of the movable base platen (6) during the compression stage. This movable base platen (6) is connected to the movable mold structure supporting the mold core (26).

Within the modular unit structure for simple injection-compression molding (20) is an hydraulic cylinder consisting of a central hydraulic block (7) constituting the jacket for said hydraulic cylinder and the hydraulic cylinder rod (8). This hydraulic cylinder rod (8) is connected to the movable base platen (6) of the module. When loading the central hydraulic block (7) with oil at a proper pressure, the hydraulic cylinder rod (8) will push the movable base platen (6), continuing the movement produced thereon by the ball screw assembly (2).

The movable base platen (6) features two types of actuation. The first one is promoted by the servomotor that, through the kinematic system consisting of the ball screw (2) and ball nut (3) assembly and the kinematic converter system consisting of at least one kinematic drive (4) and at least one sliding wedge (5).

This movement by the movable base platen (6) and thus the mold core (26) shown in FIG. 3, resulting from servomotor drive, is electronically controlled according to a displacement speed/programmable time profile. This movement by the movable base platen (6) is essentially used to perform the primary compression step, which corresponds to a partial compression still requiring a further reduced oppression on the molten polymer mass. The movement of the movable base platen (6) continues until final volume and geometry are achieved, which correspond to maximum compression, through the hydraulic cylinder assembly comprised by the central hydraulic block (7) and the hydraulic cylinder rod (8).

This hydraulic cylinder assembly is powered by a small hydraulic unit, whose oil dynamic power supply will, if possible, be provided by the injection machine, for example in the service molds, or in the case of purely electric injection machines, by a dedicated oil dynamic central supply, from the hydraulic supply point (14) shown in FIG. 2 and following.

The hydraulic unit is composed by a central hydraulic block (7) with hydraulic accumulator (13) and control valves (12) intended to control the supply of high pressure oil to the hydraulic cylinder for controlling thereof embedded in said unit. This oil comes from the hydraulic accumulator (13) which is loaded during non-compression cycle.

A pilot suction valve (15) allows sucking oil into the chamber of the central hydraulic block (7) when the hydraulic cylinder rod (8), upon the effect of movable base platen (6) traction, when it is moved by the kinematic system driven by servomotor, during primary compression stage.

Subsequently to the displacement by servomotor, piloting the suction valve (15) is cancelled and the directional control valve (12) is triggered, thus switching state. The pilot check valve (16) will then allow passage of high pressure oil into the hydraulic chamber of the central hydraulic block (7) which shall provide the necessary strength to the final compression stage. At this stage, the movable part of the mold, the mold core (26) compresses the material contained in the volume between said mold core (26) and the mold cavity (25). This compression is performed until the gap between the contact faces of the mold core (26) and mold cavity (25) is null, i.e., until the mold cavity reaches its final volume.

The primary compression (servo) and the end compression (hydraulic) movements take place only when the mold structure block A (56) and the mold structure block B (57) are completely closed by the action of the injection machine closure system, stationary platen of the injection machine (22) and movable platen of the injection machine (21).

The hydraulic and servo movement control program can optionally enable the overlapping thereof in order to take advantage from the simultaneity of compressive forces generated by each function (servo and hydraulic). The cycle is controlled by an electric control system (60) integrated in the assembly.

### Operating Cycle of a Simple Version of the Modular Unit for Injection-Compression Molding

The initial operating condition of the modular unit for injection-compression molding (1), which shall be hereinafter described, corresponds to the open mold stage as shown in FIG. 3.

So being, the operating cycle of a simple version of the modular unit for injection-compression molding (1) comprises the following steps:
the modular unit for injection-compression molding (1) is fastened to the movable platen of the injection machine (21) being guided by the centering ring of the modular unit (9);
the mold is mounted between the movable base platen (6) of the modular unit and the stationary platen of the injection machine (22);
hydraulic connection to a mold service outlet of the injection machine (14) is performed;
the closure unit sets a sufficient opening so as to create the space between the mold component structures connected to the movable platen of the injection machine (21) and to the stationary platen of the injection machine (22), respectively mold structure block A (56) and mold structure block B (57) and between the mold core (26) and the piece of the mold cavity (25) required to the complete extraction of the molded piece, whereupon conditions corresponding to the open mold stage are defined.

In this last stage, the cavity sealing rim (28) is in maximum outflow position which corresponds to the maximum expansion of the compression springs of the cavity sealing rim (29).

Once the system is in the initial conditions the mold closing stage occurs, as shown in FIG. 4.

The injection machine closure unit performs mold closing step, for such approaching the movable platen of the injection machine (21) to the stationary platen of the injection machine (22). This closing movement is completed when the mold structure pieces, in particular mold structure block A (56) and mold structure block B (57) are joined and are fastened together with the maximum closing force provided by the injection machine closure assembly.

However, within the mold and due to this mold closure movement, the mold cavity sealing rim (26) comes into contact with the mold cavity structure (25), thus closing the volume between the mold cavity (25) and the mold core (26), the sealing being ensured by the compression provided by compression springs in the cavity sealing rim (29).

Once the mold is closed, the filling stage of the mold (17) begins, as shown in FIG. 5. The injection nozzle 1 (23) of the injection machine plasticizing assembly contacts the mold inlet for injection (27) and the filling stage of the mold (17) occurs with the corresponding molten material required to the manufacture of the piece intended to be molded, which is injected into the space between the mold cavity (25) and mold core (26).

The volume created by closing the mold before injection is greater than the volume occupied by the molten material mass. The sealing of this volume, provided by the mold sealing rim (28) prevents the molten material from flowing out of the molding cavity.

Once the injection of molten material is complete, the primary compression stage (18) begins, as shown in FIG. 6.

The servomotor is set in motion by actuating the kinematic system consisting of a kinematic converter (4) and sliding wedge (5) via the ball screw (2) and ball nut (3) systems. This movement results in the displacement of the movable base platen (6) supporting the movable piece of the mold with which the mold core (26) is solidary, so that it penetrates more deeply into the interior of the mold cavity (25), reducing the volume of the space between the mold cavity (25) and the mold core (26) containing the injected molten material mass. This volume reduction of the cavity causes the molten material to compress so that once the kinematic system motion is complete, only a residual volume of some percentage units relative to the volume of the geometric form of the final molding remains unfilled.

The forces opposing the movement correspond to the deformation viscoelastic forces of the molten mass and friction forces developed between the outer layers of the molten polymer and the core and cavity surface when flowing into the free space so as to occupy it.

The compression of the compression springs in the cavity sealing rim (29) of the mold act, as implied by designation thereof, on the cavity sealing rim (28) while maintaining it adjusted to the mold cavity (25) thus ensuring the sealing of molding volume and that molten mass does not flow out of the molding cavity.

During the movement of the movable base platen (6), piloting of the pilot suction valve (15) will be present allowing the oil to be sucked into the chamber of the central hydraulic block (7). Piloting of the pilot suction valve (15) shall be complete upon completion of the movable base platen (6) and hydraulic cylinder rod (8) movement and thus also the penetration movement of the mold core (26). At this point the designated primary compression stage of molten material mass is complete with consequent nearly total filling of the mold cavity.

The final compression stage is then started, as shown in FIG. 7. The directional control valve (12) is energized and switching thereof causes the piloting of the pilot check valve (16) which opens so as to allow sending of high pressure oil contained within the hydraulic accumulator (13) to the chamber of the hydraulic central block (7).

A high momentary force onto the movable base platen (6) is thus created and consequently on the mold core (26) which compresses the molten material to its final volume corresponding to the final shape of the piece intended to be produced, before the later shrinks upon cooling and solidifying the melt.

The high hydraulic pressure will be maintained until the contraction of the molded piece is complete, i.e. until cooling time elapses. At this point, maximum penetration between the mold core (26) and the mold cavity (25) is achieved when the separating surface thereof is neutralized.

Once the programmed time for cooling the molded piece has elapsed, the extraction stage of the final piece begins, as shown in FIG. 8. The directional control valve (12) is de-energized, thus switching into idle position. The piloting of the pilot check valve (16) is withdrawn and oil is discharged from the chamber of the central hydraulic block (7) the hydraulic cylinder rod (8) being retracted. Returning the kinematic system, kinematic converter (4) and sliding wedge (5) back into the starting position enables the moving base platen (6) and consequently also the mold core (26) to retract into the starting position. In sequence or simultaneously, the movable platen of the injection machine (21) moves towards the opening of the mold so that the mold structures, mold structure block A (56) and mold structure block B (57) depart to allow the end piece (74) to be withdrawn from the mold. The withdrawal of the end piece (74) from the mold core (26) and the mold cavity (25) is carried out by mold extraction devices. The cavity sealing rim (28) also participates in the extraction of the molded piece due to recovery of the compression springs of the cavity sealing rim (29).

When the extraction stage shown in FIG. 8 is complete, the initial conditions for the next cycle are reestablished, as shown in FIG. 2.

### Operating Cycle of Complex Versions of the Modular Unit for Injection-Compression Molding

The modular unit for injection-compression molding (1) with kinematic and hydraulic system modifications can be modified to activate more than one platen. In one embodiment, shown in FIG. 9, a particular case of two opposite movable base platens (6) is shown which shall be designated as modular unit for double injection-compression molding.

The version shown in FIG. 9 allows using a central block mold or a 3-body mold, of the sandwich or stacker type, or still with two molds used in the same injection machine or still in the event wherein higher compressive forces are required which shall be obtained upon the sum of forces created by the hydraulic systems including two independent hydraulic cylinders each consisting of chambers of the central hydraulic block (7) and hydraulic cylinder rod (8) installed in opposition.

FIG. 10 shows the modular unit for injection-compression molding (1) installed in the mold structure block C (58), of a three-block mold operating in the production of multi-component pieces wherein each component processed by different plasticizing and injection assemblies, is injected through the injection nozzles 1 (23) and injection nozzles 2 (24), are molded, piece A-1 and piece B-2, respectively, at the mold cavity piece (31)/mold core piece 1 (32) and in the mold cavity piece 2 (37)/mold core piece 2 (38). Independent hydraulic circuits for controlling each movable base platen (6) allow adjusting the compression cycle according to the characteristics of the molded pieces in cavity(s) controlled by each of the opposite movable base platens (6).

Conditions shown in FIG. 10 are those existing in machine ready situation for cycle startup, the movable platen of the injection machine (21) and the stationary platen of the injection machine (22) at maximum aperture.

In the beginning of the cycle, the movable platen of the molding machine (21) and the stationary platen of the injection machine (22) move towards each other until complete closure when the mold structure block A (56) and mold structure B (57) are in contact with mold structure unit C (58). With the mold completely closed, as shown in FIG. 11, the two cavities part A-1 and part B-2 are sealed by cavity sealing rim 1 (34) and cavity sealing rim 2 (39).

Under such conditions, the filling cycle stage begins, as shown in FIG. 12, wherein the injection assembly(ies) of the machine(s) inject(s) both molding primary filling 1 (36) melt and molding primary filling 2 (42), necessary for the production of molded pieces, into the cavities, through injection nozzle 1 (23) and injection nozzles 2 (24).

Once the filling process is complete, the cycle continues with the primary compression stage, as shown in FIG. 13. The servomotor is driven such that, by means of the kinematic system consisting of ball screw (2), ball nuts (3), kinematic converters (4), and sliding wedges (5), the movable base platens (6) move and thereby the mold core 1 (32) and mold core piece 2 (38), the respective gap there between being reduced with the respective mold cavity piece 1 (31) and mold cavity piece 2 (37) thus promoting primary compression 1 (43) and primary compression 2 (44) of molten masses, until the volume within the cavities exceeds a few percentage units of the final volume of the pieces intended to be molded.

This primary compression stage movement can be modeling through servomotor control according to the characteristics desired for cavity filling influenced by polymer rheological characteristics and cavity geometrical details.

Subsequently, the final compression stage as shown in FIG. 14 takes place. This stage starts upon sequential actuation programmed in the electric control system (60) of the directional hydraulic components, directional control valve (12), pilot suction valve (15) pilot check valve (16) integrated in the hydraulic circuit, which send high pressure oil to the chambers of the central hydraulic block (7), and which complete melt mass compression by promoting the withdrawal of the rods from the hydraulic cylinder (8) and consequently from the movable base platens (6) and mold core piece 1 (32) and mold core piece 2 (38).

At the end of compression, the pieces of the mold, particularly the mold cavity piece 1 (31), mold core piece (32), mold cavity piece 2 (37) and mold core piece 2 (38), shall be nearly in contact with merely an initial separation corresponding to molded pieces contraction during the cooling and solidification of molten masses. Once cooling is complete, these pieces shall be in full contact under continuous hydraulic pressure until cooling and hence full contraction take place.

After cooling stage, the opening movement of the movable platen of the injection machine (21) performs the opening of the mold as illustrated in FIG. 15, thus starting the extraction stage. The extraction of the pieces takes place by combined action of extraction systems and cavity sealing rims integrated in the mold.

FIG. 16 represents the possibility to use a modular unit for simple injection-compression molding, together with a mold for producing a multilayer structure piece by co-injection-compression, in an injection machine not prepared with injection-compression cycle execution devices. In this case, the modular unit may comprise a dispensing and injection system (73) housing the hot dispensing and injection channels for co-injection.

The present embodiment is of course in no way restricted to the embodiments herein described and a person of ordinary skill in the art will be capable of providing many modification possibilities thereto without departing from the general idea of the invention as defined in the claims.

All embodiments described above are obviously combinable with each other. The following claims define further preferred embodiments.

1. Modular unit for injection-compression molding positioned between a movable platen of an injection machine and half-mold bearing surface resulting from the division thereof by opening joint by means of a centering ring of the modular unit and comprising:
kinematic systems consisting of at least one kinematic converter and at least one sliding wedge;
ball screw assembly;
ball nut;
a servomotor;
at least one movable base platen;
an hydraulic cylinder consisting of a central hydraulic block and hydraulic cylinder rod;
a piloted suction valve;
compression springs for cavity sealing rim;
cavity sealing rim.

2. Modular unit for injection-compression molding according to claim 1, wherein a connection is provided for pressure oil supply from the pressure line, provided by the injection machine or, when not possible, by any other alternative oil dynamic energy supply.

3. Modular unit for injection-compression molding according to claim 1 wherein hydraulic connections are provided for pressure oil supply to the control oil dynamic assembly.

4. Modular unit for injection-compression molding according to claim 1, wherein the connection between the hydraulic control circuit connecting hoses to at least one hydraulic connection and also to control and command electric signal connections carried out by interface chips between the modular unit assembly, oil dynamic energy assembly, electric control and base machine electric commands and systems are provided.

5. Modular unit for injection-compression molding according to claim 1, wherein the movable base platen is connected to the movable mold structure supporting the core of the mold and the hydraulic cylinder rod.

6. Modular unit for injection-compression molding according to claim 1, wherein a small hydraulic unit consisting of a central hydraulic block with hydraulic accumulator and control valves for controlling the hydraulic cylinder incorporated within said control unit is provided.

7. Modular unit for injection-compression molding according to claim 1, wherein an electric control system is provided.

8. Use of the modular unit for injection-compression molding according to claim 1 in the production of pieces by injecting-compressing thermoplastic polymers to any thermoplastic molding process.

9. Operating method of the modular unit for injection-compression molding according to claim 1, comprising the following steps:
fastening said modular unit for injection-compression molding to the movable platen of the injection machine being guided by the centering ring of the modular unit;
mounting the mold between the movable base platen of the modular unit and the stationary platen of the injection machine;
performing an hydraulic connection to a mold service outlet of the injection machine;
setting a sufficient opening by the closure unit so as to create the space between the mold component structures connected to the movable platen of the injection machine and to the stationary platen of the injection machine, respectively mold structure block A and mold structure block B and between the mold core and the piece of the cavity required to the complete extraction of the molded piece;
subsequent to maximum expansion of the compression springs of the cavity sealing rim, closing the mold;
subsequent to the closing of the mold, filling the mold;
once the injection of molten material is complete, beginning a primary compression stage;
the servomotor is set in motion triggering the kinematic system;
once the movement of the movable base platen has stopped, beginning a final compression stage;
once the final piece cooling time has elapsed, extracting the final piece begins;
upon ceasing of the movement of the movable base platen into its initial position, opening the mold allowing the withdrawal of the final piece;
subsequent to the removal of the final piece, restoring to the initial conditions of the first step of this method.

10. The method according to claim 9, wherein the primary compression stage includes charging oil into the hydraulic cylinder by suction through the piloted suction valve.

11. The method according to claim 9, wherein the closing stage of the mold includes approaching the movable platen of the injection machine to the stationary platen of the injection machine.

12. The method according to claim 9, wherein the final compression stage includes energizing the directional control valve causing piloting of the pilot check valve which opens in order to allow sending high pressure oil contained within the hydraulic accumulator into the chamber of the hydraulic central block.

13. The method according to claim 9, wherein the extraction stage of the final piece includes de-energizing of the directional control valve.

14. The method according to claim 9, wherein the withdrawal of the final piece is held by mold extraction devices.
